(19) United States
(12) Patent Application Publication
(10) Pub. No.: US 2016/0328495 A1
(43) Pub. Date: Nov. 10, 2016

(54) SYSTEMS AND METHODS FOR METAL CASTING DESIGN ANALYSIS

(71) Applicant: 3D FOUNDRY TECH PVT. LTD., Mumbai (IN)

(72) Inventors: Babaprasad Lanka, Mumbai (IN); Bhallamudi Ravi, Mumbai (IN); Prateek Shrivastava, Mumbai (IN); Yasarapu V. Manikanta Siva Kumar, Mumbai (IN); Varadendra Deshpande, Mumbai (IN)

(21) Appl. No.: 15/217,965

(22) Filed: Jul. 22, 2016

Related U.S. Application Data
(63) Continuation of application No. PCT/IN2015/000041, filed on Jan. 22, 2015.

(30) Foreign Application Priority Data
Jan. 22, 2014 (IN) 224/MUM/2014

(51) Int. Cl. G06F 17/50; B22D 46/00

(52) U.S. Cl. CPC G06F 17/50; B22D 46/00

(57) ABSTRACT

Methods and computer-based systems analyze designs for casting parts from molds. An input including that defines a part to be cast is received, including a mold design for the part and/or a set of graphical triangles that visually represent the part. Based on the received design, an undercut region and associated parting line location are determined. The orientation or directionality of the part for the casting may further be determined. Hotspots in the design are further identified. Based on these identified features, feeder dimensions and position are determined for the part to be cast. Directional solidification areas are further identified, and the identified characteristics are output or used to determine improved casting parameter. The part may then be poured into a casting using a mold with the determined characteristics.

### RELATED APPLICATIONS

This application claims priority under 35 U.S.C. §120 to, and is a continuation of, co-pending International Application PCT/IN2015/000041, filed Jan. 22, 2015 and designating the US, which claims priority to Indian Application 224/MUM/2014, filed Jan. 22, 2014, such Indian Application also being claimed priority to under 35 U.S.C. §119. These Indian and International applications are incorporated by reference herein in their entireties, with the exception of any disclaimers and redefinitions, including statements of the present invention.

### BACKGROUND

Casting is a manufacturing process by which a liquid material is usually poured into a mold, which contains a hollow cavity of the desired shape, and is then allowed to solidify. The solidified part is also known as a casting, which is ejected or broken out of the mold to complete the process. Casting materials are usually metals. Casting is most often used for making complex shapes that would be otherwise difficult or uneconomical to make by other methods.

In metal casting, defects and other undesired outcomes are conventionally referred to as irregularities. Some defects can be tolerated, while others can be repaired or otherwise eliminated. Irregularities are typically broken down into five main categories: gas porosity, shrinkage defects, mold material defects, pouring metal defects, and metallurgical defects.

Several parties are typically involved in a casting project. For example, product designers; a Tooling shop or pattern workshop; and/or a Foundry workshop may all be involved. Typically, a product designer aesthetically and functionally designs a product, and then the tooling shop or the foundry workshop manufactures the same. A simulation of the casting process among these parties may use multiple techniques including numerical methods to calculate cast component quality considering mold filling, solidification and cooling, and provides a quantitative prediction of casting mechanical properties, thermal stresses and distortion. Simulation accurately describes a cast component's quality up-front before production starts. The casting rigging can be designed with respect to the required component quality and properties. This has benefits beyond a reduction in pre-production sampling, as the precise layout of the complete casting system also leads to energy, material, and tooling savings.

The simulation may support a product designer in component design or the Foundry in determining melting practice and casting method, including pattern and mold making, heat treatment, and finishing. This may save costs along the entire casting manufacturing route. Feeding during casting solidification can be directly visualized by computing and plotting the path along which molten feed metal moves to compensate volumetric contraction. The soundness of a cast part depends on an uninterrupted flow of molten feed metal along feed-paths.

### SUMMARY

Example embodiments and methods include systems and method of analyzing designs for casting parts from molds, including metallic casting. Example embodiments and methods are executable with specifically-configured computers to execute example methods. Example methods may include receiving an input including that defines a part to be cast, including a mold design for the part and/or a set of graphical triangles that visually represent the part. Example systems may receive this input as a file on a non-transitory computer readable medium. Using the received design, example methods may include determining an undercut region and associated parting line location. The orientation or directionality of the part for the casting may further be determined. Hotspots in the design are further identified. Based on these identified features, feeder dimensions and position are determined for the part to be cast. Directional solidification areas are further identified, and the identified characteristics are output or used to determine improved casting parameter.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a schematic block diagram of functionalities executed by a specially-programmed computer.

FIG. 2 is a flow chart of an example method of parting line analysis.

FIG. 3 is a flow chart of another example method of parting line analysis.

FIG. 4 is a flow chart of another example method of parting line analysis.

FIG. 5 is a flow chart of another example method of parting line analysis.

FIG. 6 is a flow chart of an example method of determining feeder placement and dimensions.

FIG. 7 is an illustration of an example parting line or parting plane for a particular geometry.

FIG. 8 is an illustration of another example parting line or parting plane for a particular geometry.

FIG. 9 is an illustration of another example parting line or parting plane for a particular geometry.

FIG. 10 is an illustration of hotspots for a particular geometry.

FIG. 11 is an illustration of a feed path direction at hotspot 1 of FIG. 10.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and the are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

As used herein, the term ‘Hot Spot’ includes a region within a metal casting which is the last region to solidify. This region is prone to shrinkage porosity defect. The term ‘Directional Solidification’ includes a casting process design rules which state that solidification of molten metal should occur in such a manner that liquid feed metal is always available for that portion that is just solidifying. The term ‘Parting Line’ includes the dividing line between mold halves. The top half of the mold is called Cope and the bottom half is called Drag. The term ‘Mold’ or ‘Mold box’ includes a container into which molten liquid is poured to create a given shape when it hardens. The mold box material is typically made of sand. Other materials include metallic molds. The term ‘Voxel’ includes an array of discrete elements into which a representation of a three-dimensional object is divided. Voxels are typically to represent three dimensional space. It can be used to identify whether a region in space is occupied by part/mold/is empty, etc. The term ‘Surface Voxel’ includes voxels that are on the part surface and are visible to the mold box. The term ‘STL’ includes a triangular representation of a three-dimensional object. The term ‘Undercut’ includes any indentation or protrusion in a shape that will prevent its withdrawal from a one-piece mold. The term ‘Core’ includes a device used in casting and molding processes to produce internal cavities and reentrant angles.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The Inventors have recognized that ad hoc changes to part design, weight differences between a final and designed part, changes to part design that spoil aesthetics, increase in wall thickness in some areas, and the like impact desirability of the part. However, a functionally and aesthetically designed part by a product designer may not be easily castable. A good casting design needs to satisfy several criteria: identify the right kind of alloy and casting process, design an economical mold, ensure that the design reduces tendency to create hot spots in critical regions, ensure that the part design supports a robust rigging system which promotes directional solidification, and ensure that secondary processes reduce dimensional variation. There is a need for a product designer to have tools and apparatuses that assist in designing products for castability, thereby ensuring lower costs and better turnaround quality and time, without the differences in design and final product identified above.

The Inventors have further recognized that one of the many challenges for a product and tooling engineer is where and how to place riser bosses in sand casting process. Much time is spent in discussing with the foundry to finalize a riser location and size and/or taper angle to be provided and where a parting line should be placed. Moreover, these risers are undesirable for a product designer which implies the location and size of risers is important. Conventionally, much time and iterations are wasted in solving these problems by designing and redesigning the actual profile modeled by designer and the one achieved on castings. Additionally, sometimes a tooling designer and/or the foundry adds material to products to smoothen out surface profiles (e.g. in case of undercuts, sharp corners) to ensure less expensive moldability and smooth material flow during pouring. As such, the Inventors have newly recognized a need to provide a simulated system and method which reduces the time for casting development by providing a design with actual feedback from multiple perspectives in relation to true-world rules of casting.

The present invention is systems and methods for analyzing casting designs for a part to be cast. The present invention is not—and the Inventors explicitly disclaim—scope over a bare transitory signal or an abstract idea per se. While transitory signals and general concepts of arranging human behavior, comparing information and using rulesets based thereon, and categorizing information are useable with or in the present invention, the present invention is limited to particular implementations of those signals and concepts to improve specific articles of health information technology, such as specifically-configured patient-management hardware and software. In contrast to the present invention, the few example embodiments and example methods discussed below illustrate just a subset of the variety of different configurations that can be used as and/or in connection with the present invention.

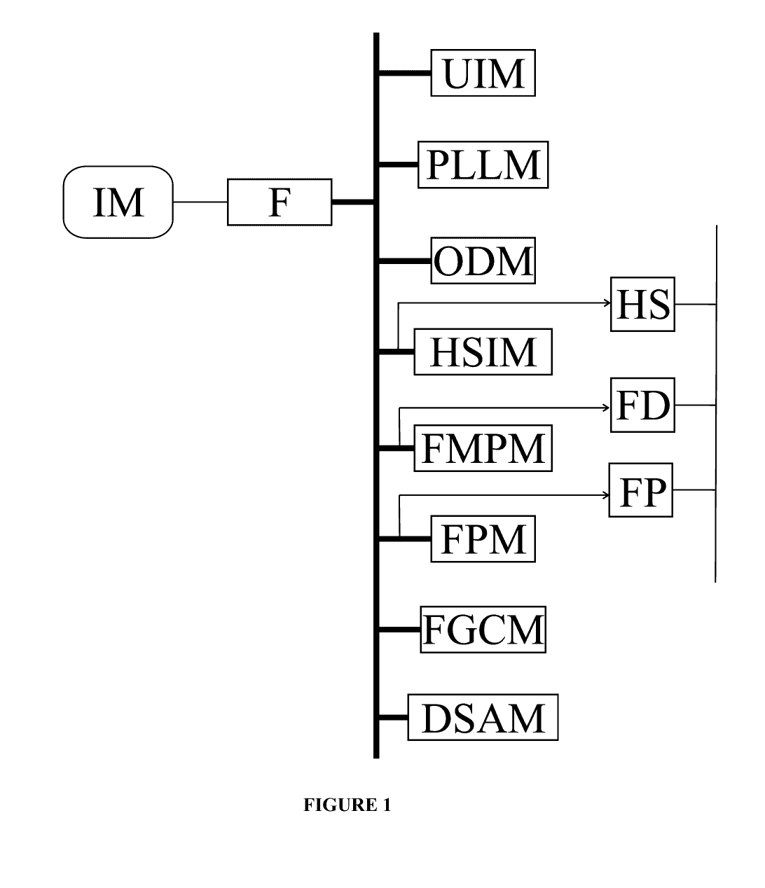

FIG. 1 illustrates a schematic block diagram of example functionalities executed by a specially-programmed computer. These functionalities are interrelated in the figures and descriptions below, which include algorithms that can be implemented in code for execution on a computer. As shown in FIG. 1, an example method may use a specially-programmed computer or network of computers to execute various functionalities through use of a computer processor and appropriately-networked transient and/or permanent memory, as well is input and output devices for the various types of information discussed below. An input mechanism IM may receive at least an input file F. For example, input file F may be a design file including a designed geometry of a mold to be cast. As a further example, input file F may be a CAD file and/or a corresponding triangulated representation of a CAD file.

An undercut identification mechanism UIM may identify undercut region(s) in the design of input file F. Undercut identification may be based on principles of geometry and computational mechanism applied thereto. A part visibility technique may be applied by undercut identification mechanism UIM. Undercut identification mechanism UIM may include voxelization functionality in order to voxelize a portion of a bounding box and compute a list of triangles intersecting with each voxel. A direction may be specified through a direction computation, and then a first associated voxel in the specified direction may be computed in respect to at least a computed triangle. In other words, for a specified direction, say +Z, a first associated voxel may be computed e.g., a voxel associated with at least one triangle for each X and Y value, starting from 0 if the direction is positive, or a last voxel in a corresponding direction if the direction is negative. For all the triangles associated with these voxels, if a normal is directed opposite to the view direction, a triangle is visible and all triangles which do not satisfy the above criteria may be obscured by default. Thus, the visible triangles form identified undercut region(s).

As seen in FIG. 1, a parting line locator PLLM may identify a parting line location based on identified undercut region(s) to identify a parting line direction. For all surface voxels, each voxel may be determined as linked to an identified undercut region(s) or undercut surface. This determination may be based on ray firing. Surface undercut voxels may be combined into well-connected areas. For each identified undercut region(s) it may be determined whether they are internal or external undercut region(s), wherein a triangle is considered to be within an internal undercut region if the triangle is obscure in both positive and negative directions of at least one orientation of the part. A visibility check may determine obscurity and the membership in an internal undercut region. Internal undercuts may be dismissed. For all possible sections along major axes, an undercut volume and area may be calculated. Part orientation may further be computer such that a heavier section is in drag.

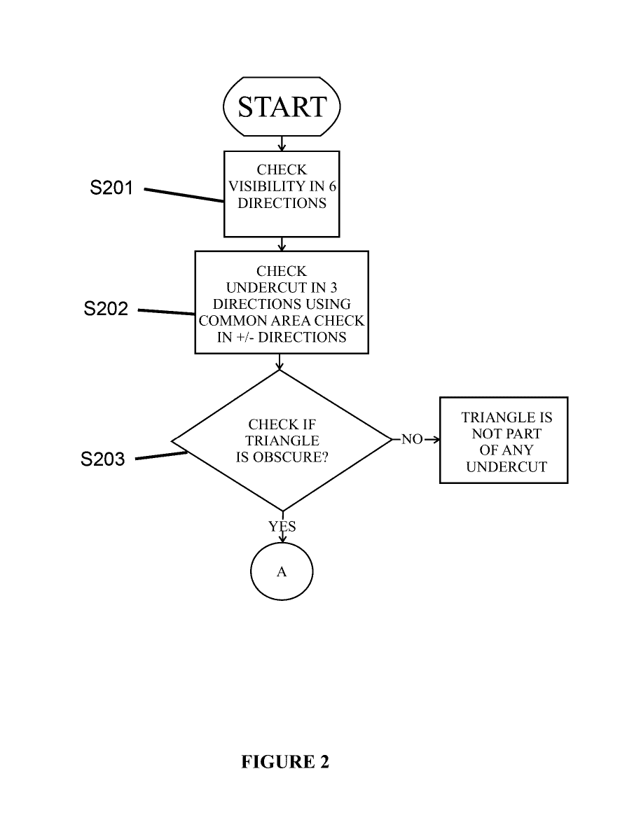

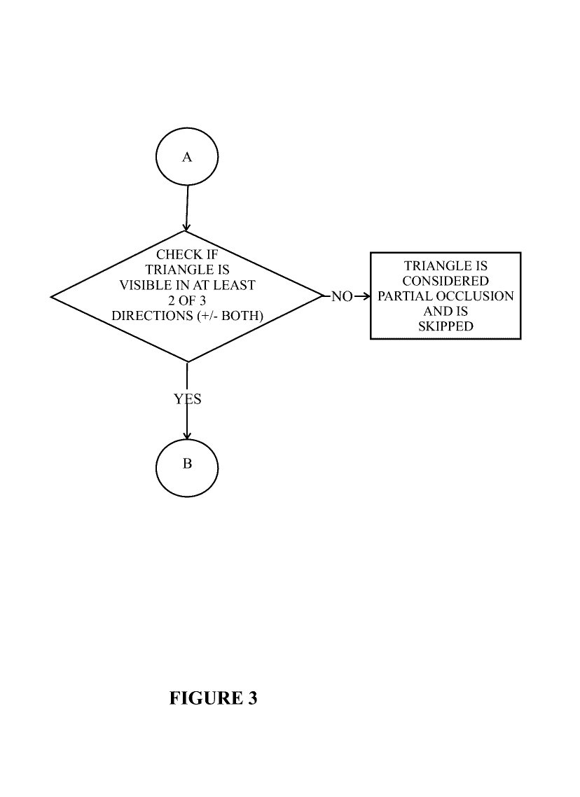

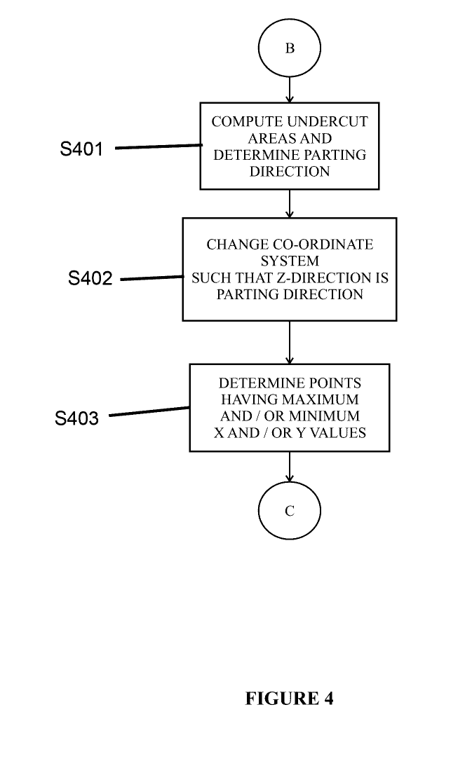

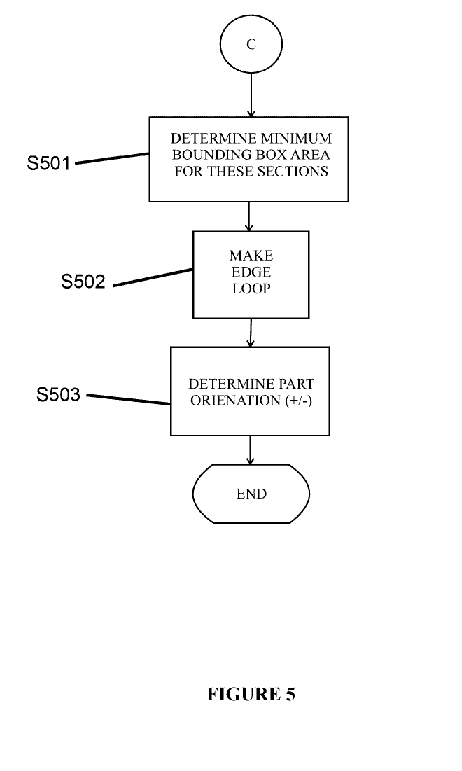

FIGS. 2-5 illustrate example methods of parting line analysis that may be undertaken by parting line locator PLLM. For example, a location of the parting line may be based on identified undercut(s). A best possible parting line location may be based on computed minimum undercut region(s). For example, the parting position locator PPLM (FIG. 1) may determine a parting direction to define a minimum undercut parting direction. In S201, a visibility may be computed in all pre-defined directions. For example, visibility may be computed in all 6+/−X/Y/Z directions. In S202, for each orientation (X/Y/Z), triangles that are not visible in both +ve and −ve direction are determined to be members of undercuts in S203. Partial occlusion triangles are triangles not visible in at least 2 orientations and may be skipped during undercut computation. In S202, an area of undercuts may be computed in each orientation (X/Y/Z). This orientation may be used with minimum undercut area as the parting direction. If more than one orientation has a minimum undercut area, then the orientation with a minimum draw may be chosen as the parting direction.

Additionally or alternatively, a location of the parting line may be based on largest silhouette. Parting line locator PLLM, may determine a location of a parting line based on largest/maximum silhouette. In S401, a parting direction may be determined. IN S402, for the chosen parting direction, part co-ordinates may be transformed such that the Z-axis is oriented towards the corresponding chosen specified direction, and the X-axis and Y-axis is oriented toward the remaining two directions. In S402, a maximum and/or minimum value for X and Y values and corresponding Z co-ordinates is determined. If more than one Z-location has maximum/minimum X/Y value, the last such value is chosen. The part is then sectioned at each of these Z-locations to form section plane(s). Part edges and vertices at the section plane(s) are then determined, and a 2D bounding box of each section plane(s) using maximum and minimum X and Y values are computed from these vertices. In S501, the section(s) of the plane are compared and chosen based on a maximum 2D bounding box area as parting line. One or more closed loops are formed from the edges of the chosen 2D bounding box, until each edge has been used in a loop. These loops are then displayed as silhouette edges as parting line with a determined part orientation in S502.

Sectioned plane(s) having a same maximum 2D bounding box area may be selected by pre-defined rules or process including, selecting sectioned plane(s) having planar faces normal to the parting direction, selecting planar faces over cylindrical faces, and selecting cylindrical faces with larger radii over those with smaller radii. Additionally, sections closer to a centroid of a given geometry may be chosen if multiple sectioned planar faces exist.

Additionally or alternatively, a location of the parting line may be based on the parting direction. Parting direction may be based on cope/drag weights and/or the part symmetry in multiple directions. For example, part symmetricity in X/Y/Z directions may be determined. A direction is specified and for the chosen specified parting direction, maximum and minimum values of the part bounding box dimension in the specific direction is computed. For example, if the specified direction is Z, maximum and minimum Z in the part bounding box is computed. The part may be split midway based on this calculation, for example, a plane parallel to Z-axis located at (Zmax+Zmin)/2. After splitting, a surface area of each of the two split parts may be calculated and compared, and if both the sectional or split areas are equal within tolerance, the part is considered symmetric in the corresponding or specified direction. If the part is symmetric in more than one direction, the direction with minimum draw may be chosen as parting direction. Otherwise, the parting direction may be selected based on minimum external undercuts determined above. Additionally, or alternatively, a minimum draw may be computed and selected based on a 2D bounding box computation for each of the determined axes of symmetricity.

A location of the parting line may also be based on metal and process of casting, on a face type of the input file including the part's designed geometry such as whether the part is planar, cylindrical, or the like, and/or on feed path to an identified hotspot.

The parting line locator PLLM may calculate a minimum draw parting direction. In this calculation, at least one direction is specified, and for each specified direction, part co-ordinates are transformed such that the Z-axis is oriented toward the corresponding chosen specified direction. A maximum and minimum Z value is then calculated. The direction with maximum value of (Zmax, Zmin) is then chosen as parting direction.

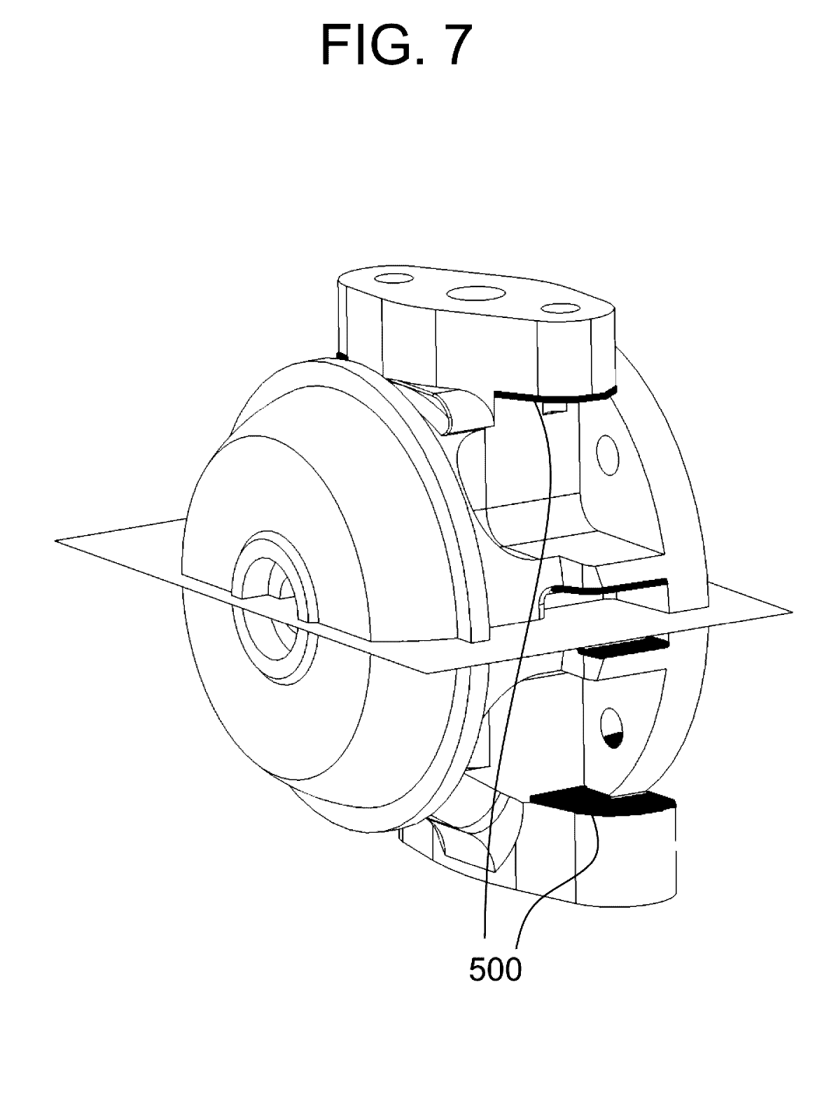

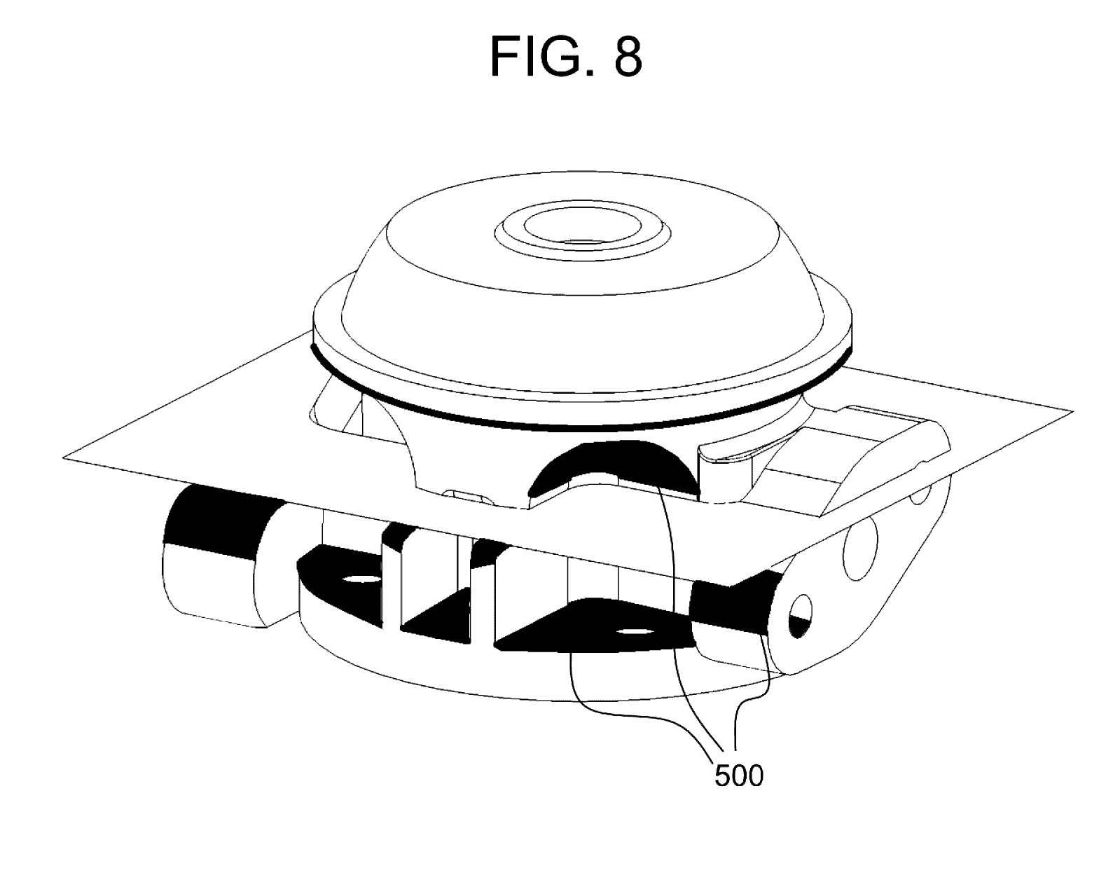

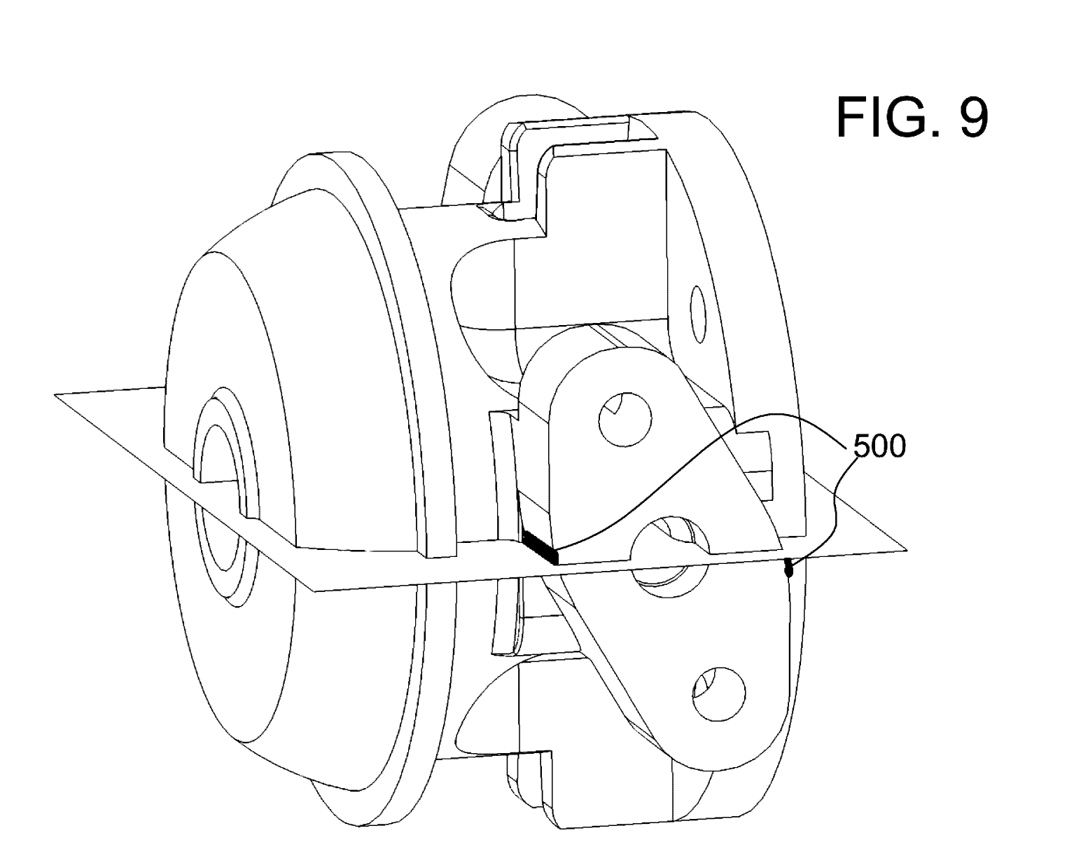

FIGS. 7-9 are examples of parting planes calculated by example methods for a given geometry, each with a different parting plane. Solid black areas 500 are undercuts in each of the FIGS. 7, 8, and 9. The parting plane of FIG. 9 may be considered optimum because it has minimum undercuts (only a single solid black area).

As seen in FIG. 1, an orientation definer ODM defines orientation of part corresponding to the mold/casting assembly for casting. Orientation determination may be based on pre-defined parameters relating to identification of undercut, identification of parting line, and the like parameters.

For example, orientation definer ODM may determine part orientation based on several factors. A parting line may be chosen and for the chosen parting line, the part is transformed such that Z-axis points toward the parting direction. The transformed co-ordinates of part vertices are used to compute maximum and minimum transformed Z-co-ordinates, and corresponding vertices are taken as extreme points from the parting line. The is then drawn on the part. Distance between the two vertices (maximum Z and minimum Z) from a parting line are then calculated and compared to determine a side with a relatively larger distance. This side is designated the drag side, and the side with a relatively smaller distance is designated the cope side.

Or, for example, orientation definer ODM chooses a parting line and for the chosen parting line, the part is split and the weight of the part above and below the parting line are compared. A drag side is designated as the side with a relatively higher weight, and a cope side has a relatively lower weight.

Or, for example, orientation definer ODM may identify the location of major hotspots and sues the same to determine part orientation. The drag side is designated as a side with a relatively lower concentration of hotspots, and a cope side is designated as a side with a relatively higher concentration of hotspots.

A hotspot identifier HSIM may identify hot spots (HS) in the designed geometry of the input file. For example, a gradient vector method can identify hotspots for casting designed based on fundamental principles of heat transfer, cooling principles, flow of molten mass, thermodynamics, and the like. The casting solidifies progressively from the mold walls until it converges to isolated last solidifying points in the mold, known as hot-spots. The liquid-solid interface converges at hot-spots, forming a singularity. Or, for example, a hybrid gradient vector method can compute the feed-paths by continuously tracing an interface evolution with the help of mass-less particles in the normal direction. Locations of hot-spot is calculated as the point at which the advection of mass-less particles converged, in other words, the point from where feed-paths originated.

Temperature of the part voxels can be calculated by hot spot identifier HSIM using a gradient vector method as well. Geometry of a part affects temperature distribution across the part. Temperature may be normalized across all the part voxels with respect to a maximum temperature among the part voxels, for example, with a maximum normalized temperature being 1 and minimum normalized temperature being 0. A hotspot temperature cutoff is determined as the ratio of materials solidus temperature to material liquidus temperature. All voxels are marked with normalized temperature greater than hotspot temperature cutoff as possible hotspot voxels. The marked hotspot voxels are then combined. Volume of all the marked hotspots may also be determined by the number of voxels marked as hotspots. In this way, hotspot identifier HSIM may mark all voxels with normalized temperature greater than hotspot temperature cutoff as possible hotspot voxels, combine the identified hotspot voxels, and determine a volume of the combined hotspots by the number of voxels so combined.

As shown in FIG. 1, example methods may further include a feeder modulus computer FMCM to compute feeder dimensions FD for the part that is to be cast. Feeder dimensions can be optimized so that they are not oversized, yet feed the part. Example systems and methods may compute feeder dimensions based on modulus values. For example, a modulus can be defined as [Volume]/[Area]. As seen, computation of modulus by feeder modulus computer may include at least two steps: 1) computation of area; and 2) computation of volume. For computation of area, for each surface voxel, the method may trace the part in the direction of temperature gradient till a hotspot voxel is reached. If the hotspot is the one for which modulus is being computed, an area count is increased by 1. In this way, area=[Area Count]*[Surface Area of one face of a voxel]. For computation of volume, the method may calculate [Number of voxels having hotspot attribute]*[Volume of one voxel].

Modulus of feeder may be determined as a function of modulus of casting region and a feeder design factor based on material. Gradient may be computed the same as temperature defined above. Modulus computation for each hotspot may include for all voxels, determining a gradient along which the metal is expected to flow. Then determine for all surface voxels which voxels' feed path converges in to the hotspot. This identification of such surface voxels may be used to determine surface area. All voxels—on the surface as well as those inside—that converge in to the hotspot are counted. This count is used to determine the volume. Modulus is calculated by volume/surface area, and feeder modulus=1.2*Modulus. Neck modulus=1.1*Modulus. The values 1.2 and 1.1 are based on the material, process being used. In this way, feeder dimensions and a position of feeder as side, top, or angular may be determined by hotspot modulus.

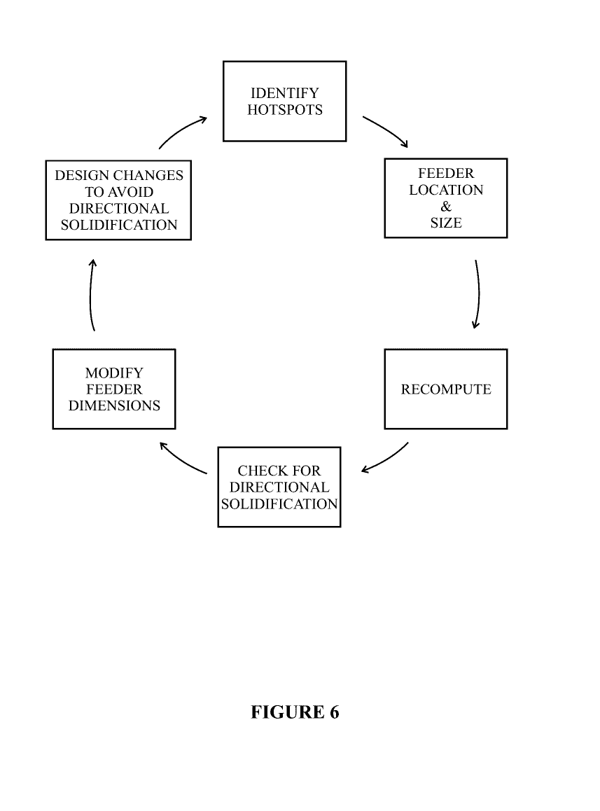

FIG. 6 is an illustration of an example method interrelating feeder placement and feeder dimensions. For example, feeder positioner FPM (FIG. 1) may determine feeder position (FP) in relation to pre-determined parameters. After determining feeder dimensions, feeder location may be determined. Feeder location is determined based on feed path—to effectively feed the hotspot, fettleability—to place the feeder properly, intersection checks—to ensure feeder is not too close to the original part surface, and directional solidification—to have defect-free castings. Fettleability is dependent upon feedpath to identified hotspot(s). Fettleability may also be based on face type of feeder. Example methods may attach feeders to flat faces or faces with large curvatures.

For example, feeder positioner FPM may evaluate a hot spot region to identify the centroid and hottest temperature of the region. The part may be further evaluated and analyzed to look for flat areas for feeder attachment so that fettling of feeder will not be a problem. In this way example systems and methods can suggest a feeder position or a user can override the suggestion and manually locate a feeder position. The following process may identify feeder placement faces for top and side feeders based on fettleability considerations: first priority—planar faces; second priority—cylindrical faces; for each location, ensure that part thickness is more than feeder thickness by a factor of 1.5; for hotspots closer to a top of the part, top feeders are preferred, while side feeders are avoided; for hotspots closer to parting line, side feeders are preferred while top feeders are acceptable; and any additional rules, for example, for a pressure part, the side feeder is placed on a cylindrical flange even though the flat face is available.

A feeder geometry computer FGCM may compute feeder geometry based on pre-defined parameters relating to casting, relating to designed object, and/or relating to identified parameters of the object and casting. Feeder geometry computer FGCM may determines feeder dimension(s) based on hotspot modulus. For example, a neck modulus is 1.2 times the hotspot modulus, and a feeder modulus is 1.4 times the hotspot modulus. Depending on type of feeder (side/top), the neck is either rectangular or circular in cross section, and the feeder is usually cylindrical.

Solidification of the feeder during casting will typically take place later than the nearest hot spot, expressed by the criterion: Mf=kf*Mh. Here, the modulus of the feeder is given by Mf, the modulus of the casting region around the hot spot is given by Mh, and the feeder design factor is given by kf. The feeder design factor is usually more than 1 (more than 1.1 for ductile iron casting, and more than 1.2 for Aluminum and steel casting). A larger factor might be needed (1.4 or more), if there is an intermediate section of casting between the feeder and the hot spot. After connecting the feeder, the modulus of the hot spot region will increase because the heat transfer area corresponding to the feeder neck will be reduced. Thus, the feeder size may be further increased to take increase this into account.

A directional solidification analyzer DSAM may indicate problem areas during casting. For each part hotspot, a section is taken with the feeder; a unique path is identified joining the part hotspot and feeder hotspot; and then temperature along the path joining hotspot and feeder is analyzed to look for any undesired pattern. Rules for undesired patterns may be defined based on material, process, geometry inter-relationships, etc. Lastly, changes in design may be suggested based on undesired patterns.

Directional solidification analyzer may determine directional solidification based on temperature along path joining hotspots. Temperature likely rises closer to feeder hotspot. A minimum/maximum temperature difference should not have difference of more than 300 C. Directional solidification may be based upon a length of the part, and even with an expected temperature graph, directional solidification may not happen if the length along the graph is large. Directional solidification may be determined, for each hotspot: 1) if part volume of the hotspot is zero, direction solidification is identified; 2) associate the nearest feeder hotspot as a feeder hotspot, which may or may not be connected with the hotspot being iterated; 3) estimate the shortest path joining a core of the part hotspot and a core of the feeder hotspot along the skeleton computed using Palagyi's technique. This technique may involve defining the nearest voxel on a skeleton as end points and using Dijkstra's technique to find the shortest path. Then, if along the path, if at any voxel, the difference between voxel temperature and end point temperature is more than 300 C, then the hotspot is identified as not being fed, and directional solidification is not occurring.

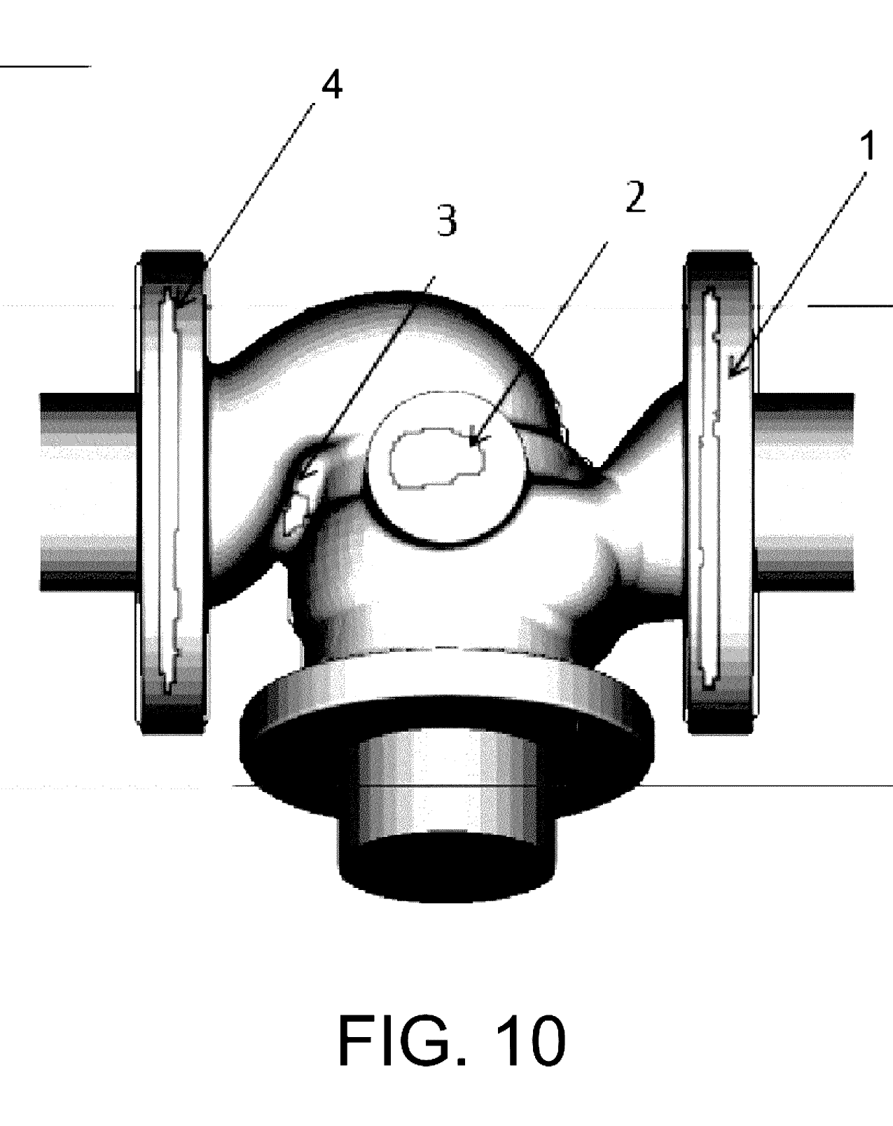

FIG. 10 is an illustration of hotspots at highest thresholds. As seen in FIG. 10, reference numerals 1, 2, 3, and 4 are hotspots wherein hotspots 1, 3, and 4 are hotspots near to parting line or parting plane and hotspots 2 and 3 are in cope. Therefore, feeder placement determined by example methods for the part of FIG. 10, is as follows:

TABLE 1

| | Cope, Drag, | Near to | | |
|---|---|---|---|---|
| Hot Spot # | Both | Parting Line | Top Feeder | Side Feeder |
| 1 | Both | Yes | Possible | Possible |
| 2 | Cope | No | Yes | No |
| 3 | Cope | Yes | Very Difficult | No |
| 4 | Both | Yes | Possible | Possible |

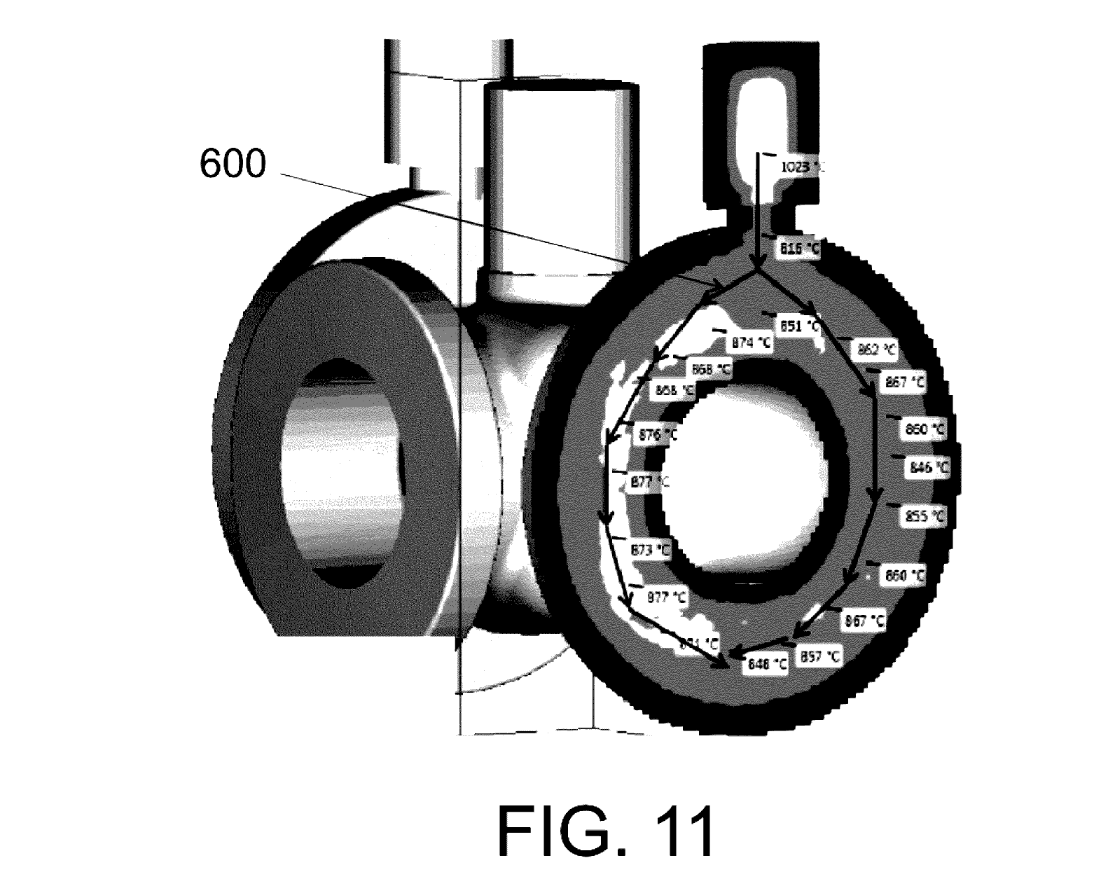

FIG. 11 illustrates feed path direction FPD 600 at a hotspot 1 of the part of FIG. 10 according to example methods, where:

TABLE 2

| Hotspot | Feeder | | | Directional |
|---|---|---|---|---|
| Number | Modulus | Top/Side | Fettlable | problem |
| 1 | 10.34 | Top | Yes | No |
| 2 | 12.19 | Top | Yes | No |
| 3 | | No Feeder | No | Yes |
| 4 | 10.34 | Top | Yes | No |

The data, in each of the components, means, modules, mechanisms, units, devices of example systems and methods may be ‘encrypted’ and suitably ‘decrypted’ when required. Encryption can be accomplished using any encryption technology, such as the process of converting digital information into a new form using a key or a code or a program, wherein the new form is unintelligible or indecipherable to a user or a thief or a hacker or a spammer. The term ‘encryption’ includes encoding, compressing, or any other translating of the digital content. The encryption of the digital media content can be performed in accordance with any technology including utilizing an encryption algorithm. The encryption algorithm utilized is not hardware dependent and may change depending on the digital content. For example, a different algorithm may be utilized for different websites or programs. The term ‘encryption’ further includes one or more aspects of authentication, entitlement, data integrity, access control, confidentiality, segmentation, information control, and combinations thereof.

These example systems and methods can be made accessible through a portal or an interface which is a part of, or may be connected to, an internal network or an external network, such as the Internet or any similar portal. The portals or interfaces are accessed by one or more of users through an electronic device, whereby the user may send and receive data to the portal or interface which gets stored in at least one memory device or at least one data storage device or at least one server, and utilizes at least one processing unit. The portal or interface in combination with one or more of memory device, data storage device, processing unit and serves, form an embedded computing setup, and may be used by, or used in, one or more of a non-transitory, computer readable medium. In at least one embodiment, the embedded computing setup and optionally one or more of a non-transitory, computer readable medium, in relation with, and in combination with the said portal or interface forms one of the systems of the invention. Typical examples of a portal or interface may be selected from but is not limited to a website, an executable software program or a software application.

The systems and methods may simultaneously involve more than one user or more than one data storage device or more than one host server or any combination thereof. In at least one embodiment, one or more user can be blocked or denied access to one or more of the aspects of the invention.

A user may provide user input through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, pointing stick, etc.

Example systems and methods can be practiced using computer processor-based devices which may be connected to one or more of other electronic device with wires or wirelessly which may use technologies such as but not limited to, NFC, Bluetooth, Wi-Fi, Wimax. This will also extend to use of the aforesaid technologies to provide an authentication key or access key or electronic device based unique key or any combination thereof.

The described embodiments may be implemented as a system, method, apparatus or article of manufacture using standard programming and/or engineering techniques related to software, firmware, hardware, or any combination thereof. The described operations may be implemented as code maintained in a “non-transitory, computer readable medium”, where a processor may read and execute the code from the non-transitory, computer readable medium. A non-transitory, computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). The term network means a system allowing interaction between two or more electronic devices, and includes any form of inter/intra enterprise environment such as the world wide web, Local Area Network (LAN), Wide Area Network (WAN), Storage Area Network (SAN) or any form of Intranet.

While code implementing the described operations may be transmitted in “transmission signals,” where transmission signals may propagate through space or through a transmission media, such as an optical fiber, copper wire, etc. in the form of a wireless signal, satellite transmission, radio waves, infrared signals, Bluetooth, etc., any claimed code or logic is stored in hardware or a non-transitory, computer readable medium at the receiving and transmitting stations or devices. Further, a device in which the code implementing the described embodiments of operations is encoded may comprise a non-transitory, computer readable medium or hardware logic. Of course, those skilled in the art will recognize that many modifications may be made to this configuration without departing from the scope of the present invention, and that the article of manufacture may comprise suitable information bearing medium known in the art.

Example systems and methods can use properly configured personal computers, tablet computers, mobile phones, laptop computers, palmtops, portable media players, and personal digital assistants. In an embodiment, the computer readable medium data storage unit or data storage device, or input file F may be selected from a set of but not limited to USB flash drive (pen drive), memory card, optical data storage discs, hard disk drive, magnetic disk, magnetic tape data storage device, data server and molecular memory.

Some example methods being described here and in the incorporated documents, it is understood that one or more example methods may be used in combination and/or repetitively to produce multiple options and functionalities for subscribers. Example methods may be performed by properly programming or hardware configuring systems for casting analysis to receive casting designs and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

Example methods and embodiments thus being described, it will be appreciated by one skilled in the art that example embodiments may be varied through routine experimentation and without further inventive activity. For example, although compared healthcare information used to determine a readmission is shown as originating from two independent healthcare providers having it is understood that a readmission may be determined and alert issued from healthcare information all received from a same, commonly-controlled provider. Variations are not to be regarded as departure from the spirit and scope of the exemplary embodiments, and all such modifications as would be obvious to one skilled in the art are intended to be included within the scope of the following claims.

What is claimed is:

1. A computer system for design analysis for a casting for a part, said system comprising:
an input configured to receive an input file including design data for the part, including a set of triangles that represent the part; and
a computer processor configured to,
determine an undercut region in the design data,
determine a parting line location based on the undercut region and determine a parting line direction,
determine an orientation of the part with respect to the casting,
determine a hotspot in the design data,
determine feeder dimensions for the part based on the hotspot,
determine a feeder position with respect to the casting,
determine directional solidification areas due to shrinkage porosity during casting solidification, and
output the orientation of the part, the feeder dimensions, the feeder position, and the directional solidification areas for casting the part.

2. The system of claim 1, wherein, the determining the undercut region includes,
voxelizing a mold box,
determining a plurality of triangles intersecting with each voxel,
determining a direction, and
determining a first associated voxel in the direction in respect to at least a computed triangle of the plurality of triangles, wherein,
when a normal is directed opposite to the direction, the computed triangle is visible, all visible triangles of the plurality of triangles form the undercut region, and all other triangles of the plurality of triangles are obscured.

3. The system of claim 1, wherein the determining the parting line location includes,
determining whether all surface voxels are linked to the undercut region,
determining if the surface voxels are combined into well-connected areas,
determining if the undercut region is an internal undercut region or an external undercut region, wherein a triangle is considered to be part of an internal undercut region if the triangle is obscure in both positive and negative directions of the orientation of the part,
determining an undercut volume and undercut area for the external undercut region along major axes, and
determining a part orientation based on the undercut volume and the undercut area, wherein, a drag of the part is a relatively heavier part and a cope the part is a relatively lighter part.

4. The system of claim 1, wherein determining the parting line location includes,
determining a minimum undercut parting direction,
determining a visibility in a plurality of directions,
determining an area of the undercut region in each orientation, and
determining a minimum draw as the parting line direction if more than one orientation has a minimum area.

5. The system of claim 1, wherein determining the parting line location includes,
determining a location of the parting line based on largest silhouette,
determining a parting direction,
transforming co-ordinates of the design based on the parting direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
sectioning the part at each of the corresponding Z co-ordinates so as to form sectioned planes of the part,
determine part edges and vertices at each of the sectioned planes,
determine a 2D bounding box of each of the sectioned planes using the maximum and minimum X and Y values,
selecting a sectioned plane with a maximum 2D bounding box area as the parting line, wherein, when there are multiple of the sectioned planes in said 2D bounding box, the selected sectioned plane(s) has a maximum 2D bounding box areas as determined by selecting sectioned planes having planar faces normal to the parting direction, selecting planar faces over cylindrical planar faces in the sectioned planes, selecting cylindrical faces with larger radii over those with smaller radii in the sectioned planes, and selecting sections closer to a centroid of a geometry in the sectioned planes,
determining closed loops from all the edges of the 2D bounding box, and
forming and displaying the loops of silhouette edges as the parting line.

6. The system of claim 1, wherein determining the parting line location includes,
computing a part symmetricity in all directions,
determining a parting direction,
transforming co-ordinates of the design based on the parting direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
sectioning the part at each of the corresponding Z co-ordinates so as to form sectioned planes of the part,
determine part edges and vertices at each of the sectioned planes,
determine a 2D bounding box of each of the sectioned planes using the maximum and minimum X and Y values,
determining if the part is symmetric in more than one direction, and if the part is symmetric in more than one direction, determining a direction with a minimum draw as the parting direction, else determining the direction with minimum external undercuts as the parting direction, and
determining a minimum draw based on the 2D bounding box for each of the axes of symmetricity.

7. The system of claim 1, wherein determining the parting line location includes locating the parting line based on a feed path to an identified hotspot in the design.

8. The system of claim 1, wherein determining the parting line location includes,
defining a minimum draw parting direction,
transforming co-ordinates of the design based on the minimum draw parting direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates, and
sectioning the part at each of the corresponding Z co-ordinates so as to form sectioned planes of the part.

9. The system of claim 1, wherein determining the orientation includes,
determining a part orientation direction,
transforming co-ordinates of the design based on the part orientation direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
determining the parting line wherein corresponding vertices are taken as extreme points from the parting line,
determining a distance between a maximum and a minimum Z vertex from the parting line for each side of the design,
determining a side of the design with a relatively larger distance in order to determine it as drag side, and
determining a side of the design with a relatively smaller distance in order to determine it as cope side.

10. The system of claim 1, wherein determining the orientation includes,
determining a part orientation direction,
transforming co-ordinates of the design based on the part orientation direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
drawing the parting line wherein corresponding vertices are taken as extreme points from the parting line,
splitting the part at the parting line and comparing a weight of the part above and below the parting line,
determining a side with a relatively higher weight as a drag side, and
determining a side with a relatively lower weight as a cope side.

11. The system of claim 1, wherein determining the orientation includes,
determining a part orientation direction,
transforming co-ordinates of the design based on the part orientation direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
drawing the parting line wherein corresponding vertices are taken as extreme points from the parting line,
determining a side with a relatively lower concentration of hotspots as a drag side, and
determining a side with a relatively higher concentration of hotspots as a cope side.

12. The system of claim 1, wherein the computer processor is further configured to,
compute temperature of part voxels using a gradient vector method,
normalize temperature of all the voxels with respect to a maximum temperature among the voxels, with a maximum normalized temperature being 1 and a minimum normalized temperature being 0,
determine hotspot temperature cutoff as a ratio of materials solidus temperature to material liquidus temperature,
determining all voxels with normalized temperature greater than hotspot temperature cutoff as hotspot voxels,
determining a volume of all hotspots, by,
determining volume of all hotspots as a number of the determined voxels, and
determining an area for each surface voxel by multiplying an area count by a surface area of each voxel, wherein the area count is determined by proceeding in the direction of a temperature gradient till a hotspot voxel is reached, and increasing an area count by a factor if the hotspot is the one for which a modulus is being computed,
determining the volume by multiplying each hotspot voxel with a volume of the voxel,
determining a modulus as a ratio of the determined volume to the determined surface area,
determining a feeder modulus as a factor of computed modulus, thereby determining feeder dimensions, wherein the factor is selected based on material and process being used in the casting, and
computing a neck modulus as a factor of computed modulus, wherein the factor is selected based on material and process being used.

13. The system of claim 1, wherein determining the feeder position includes,
determining a hot spot region by a centroid and hottest temperature,
determining feed path in order to effectively feed the hotspot, and
determining directional solidification.

14. The system of claim 1, wherein determining the feeder position includes,
determining fettleability,
determining intersection checks so that the feeder position is not near an original part surface, and
determining fettleability for flat areas of the design.

15. The system of claim 1, wherein determining the feeder position includes,
giving planar faces first priority,
giving cylindrical faces second priority,
determining a feeder position such that part thickness is more than feeder thickness by a pre-determined factor,
for hot spots closer to top of the part, preferring top feeders, and
for hot spots closer to the parting line, preferring side feeders.

16. The system of claim 1, wherein the computer processor is further configured to determine feeder geometry based on casting and the part, including at least one of,
determining feeder dimensions based on a hotspot modulus, wherein a neck modulus is a pre-determined factor of the hotspot modulus,
determining feeder dimensions based on a feeder modulus, wherein the feeder modulus is a pre-determined factor of hotspot modulus, and
determining feeder dimensions based on a function of modulus of casting region and a feeder design factor based on material.

17. The system of claim 1, wherein determining the solidification direction includes,
for each part hotspot, determining a section with a feeder,
determining a unique path being identified for joining the part hotspot and the feeder hotspot,
determining temperature along the unique path joining the hotspot and feeder to identify any undesired patterns based on material, process and geometry inter-relationships in the design, and
iterating changes in design if undesired patters are determined.

18. The system of claim 1, wherein determining the solidification direction includes, for each hotspot,
determining that if volume of the hotspot in part is zero, then direction solidification is occurring,
determining a nearest feeder hotspot as the feeder hotspot;
determining a shortest path joining a core of the part hotspot and a core of the feeder hotspot along a skeleton, wherein the skeleton is determined using Palagyi's technique by defining the nearest voxel on the skeleton as end points; and
determining along the shortest path, if at any voxel, the difference between a voxel temperature and an end point temperature is more than a predefined temperature then considering the hotspot as not being fed and therefore determining that directional solidification is not occurring.

19. A method of design analysis for a casting for a part, the method comprising:
inputting an input file including design data for the part, including a set of triangles that represent the part;
determining an undercut region in the design data;
determining a parting line location based on the undercut region and determine a parting line direction;
determining an orientation of the part with respect to the casting;
determining a hotspot in the design data;
determining feeder dimensions for the part based on the hotspot;
determining a feeder position with respect to the casting;
determining directional solidification areas due to shrinkage porosity during casting solidification; and
outputting the orientation of the part, the feeder dimensions, the feeder position, and the directional solidification areas for casting the part.

20. The method of claim 19, wherein, the determining the undercut region includes,
voxelizing a mold box,
determining a plurality of triangles intersecting with each voxel,
determining a direction, and
determining a first associated voxel in the direction in respect to at least a computed triangle of the plurality of triangles, wherein,
when a normal is directed opposite to the direction, the computed triangle is visible, all visible triangles of the plurality of triangles form the undercut region, and all other triangles of the plurality of triangles are obscured.

21. The method of claim 19, wherein the determining the parting line location includes,
determining whether all surface voxels are linked to the undercut region,
determining if the surface voxels are combined into well-connected areas,
determining if the undercut region is an internal undercut region or an external undercut region, wherein a triangle is considered to be part of an internal undercut region if the triangle is obscure in both positive and negative directions of the orientation of the part,
determining an undercut volume and undercut area for the external undercut region along major axes, and
determining a part orientation based on the undercut volume and the undercut area, wherein, a drag of the part is a relatively heavier part and a cope the part is a relatively lighter part.

22. The method of claim 19, wherein determining the parting line location includes,
determining a minimum undercut parting direction,
determining a visibility in a plurality of directions,
determining an area of the undercut region in each orientation, and
determining a minimum draw as the parting line direction if more than one orientation has a minimum area.

23. The method of claim 19, wherein determining the parting line location includes,
determining a location of the parting line based on largest silhouette,
determining a parting direction,
transforming co-ordinates of the design based on the parting direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
sectioning the part at each of the corresponding Z co-ordinates so as to form sectioned planes of the part,
determine part edges and vertices at each of the sectioned planes,
determine a 2D bounding box of each of the sectioned planes using the maximum and minimum X and Y values,
selecting a sectioned plane with a maximum 2D bounding box area as the parting line, wherein, when there are multiple of the sectioned planes in said 2D bounding box, the selected sectioned plane(s) has a maximum 2D bounding box areas as determined by selecting sectioned planes having planar faces normal to the parting direction, selecting planar faces over cylindrical planar faces in the sectioned planes, selecting cylindrical faces with larger radii over those with smaller radii in the sectioned planes, and selecting sections closer to a centroid of a geometry in the sectioned planes,
determining closed loops from all the edges of the 2D bounding box, and
forming and displaying the loops of silhouette edges as the parting line.

24. The method of claim 19, wherein determining the parting line location includes,
computing a part symmetricity in all directions,
determining a parting direction,
transforming co-ordinates of the design based on the parting direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
sectioning the part at each of the corresponding Z co-ordinates so as to form sectioned planes of the part,
determine part edges and vertices at each of the sectioned planes,
determine a 2D bounding box of each of the sectioned planes using the maximum and minimum X and Y values,
determining if the part is symmetric in more than one direction, and if the part is symmetric in more than one direction, determining a direction with a minimum draw as the parting direction, else determining the direction with minimum external undercuts as the parting direction, and
determining a minimum draw based on the 2D bounding box for each of the axes of symmetricity.

25. The method of claim 19, further comprising:
pouring the design using the output.

26. The method of claim 19, wherein determining the parting line location includes,
defining a minimum draw parting direction,
transforming co-ordinates of the design based on the minimum draw parting direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates, and
sectioning the part at each of the corresponding Z co-ordinates so as to form sectioned planes of the part.

27. The method of claim 19, wherein determining the orientation includes,
determining a part orientation direction,
transforming co-ordinates of the design based on the part orientation direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
determining the parting line wherein corresponding vertices are taken as extreme points from the parting line,
determining a distance between a maximum and a minimum Z vertex from the parting line for each side of the design,
determining a side of the design with a relatively larger distance in order to determine it as drag side, and
determining a side of the design with a relatively smaller distance in order to determine it as cope side.

28. The method of claim 19, wherein determining the orientation includes,
determining a part orientation direction,
transforming co-ordinates of the design based on the part orientation direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
drawing the parting line wherein corresponding vertices are taken as extreme points from the parting line,
splitting the part at the parting line and comparing a weight of the part above and below the parting line,
determining a side with a relatively higher weight as a drag side, and
determining a side with a relatively lower weight as a cope side.

29. The method of claim 19, wherein determining the orientation includes,
determining a part orientation direction,
transforming co-ordinates of the design based on the part orientation direction so that a Z-axis is oriented toward the parting direction with an X-axis and a Y-axis perpendicular to the Z-axis and each other,
determining maximum X and Y values and corresponding Z co-ordinates,
determining minimum X and Y values and corresponding Z co-ordinates,
drawing the parting line wherein corresponding vertices are taken as extreme points from the parting line,
determining a side with a relatively lower concentration of hotspots as a drag side, and
determining a side with a relatively higher concentration of hotspots as a cope side.

30. The method of claim 19, wherein the computer processor is further configured to,
compute temperature of part voxels using a gradient vector method,
normalize temperature of all the voxels with respect to a maximum temperature among the voxels, with a maximum normalized temperature being 1 and a minimum normalized temperature being 0,
determine hotspot temperature cutoff as a ratio of materials solidus temperature to material liquidus temperature,
determining all voxels with normalized temperature greater than hotspot temperature cutoff as hotspot voxels,
determining a volume of all hotspots, by,
determining volume of all hotspots as a number of the determined voxels, and
determining an area for each surface voxel by multiplying an area count by a surface area of each voxel, wherein the area count is determined by proceeding in the direction of a temperature gradient till a hotspot voxel is reached, and increasing an area count by a factor if the hotspot is the one for which a modulus is being computed,
determining the volume by multiplying each hotspot voxel with a volume of the voxel,
determining a modulus as a ratio of the determined volume to the determined surface area,
determining a feeder modulus as a factor of computed modulus, thereby determining feeder dimensions, wherein the factor is selected based on material and process being used in the casting, and
computing a neck modulus as a factor of computed modulus, wherein the factor is selected based on material and process being used.

31. The method of claim 19, wherein determining the feeder position includes,
determining a hot spot region by a centroid and hottest temperature,
determining feed path in order to effectively feed the hotspot, and
determining directional solidification.

32. The method of claim 19, wherein determining the feeder position includes,
determining fettleability,
determining intersection checks so that the feeder position is not near an original part surface, and
determining fettleability for flat areas of the design.

33. The method of claim 19, wherein determining the feeder position includes,
giving planar faces first priority,
giving cylindrical faces second priority,
determining a feeder position such that part thickness is more than feeder thickness by a pre-determined factor,
for hot spots closer to top of the part, preferring top feeders, and
for hot spots closer to the parting line, preferring side feeders.

34. The method of claim 19, further comprising:
determining a feeder geometry based on casting and the part, including at least one of,
determining feeder dimensions based on a hotspot modulus, wherein a neck modulus is a pre-determined factor of the hotspot modulus,
determining feeder dimensions based on a feeder modulus, wherein the feeder modulus is a pre-determined factor of hotspot modulus, and
determining feeder dimensions based on a function of modulus of casting region and a feeder design factor based on material.

35. The method of claim 19, wherein determining the solidification direction includes,
for each part hotspot, determining a section with a feeder,
determining a unique path being identified for joining the part hotspot and the feeder hotspot,
determining temperature along the unique path joining the hotspot and feeder to identify any undesired patterns based on material, process and geometry inter-relationships in the design, and
iterating changes in design if undesired patters are determined.

36. The method of claim 19, wherein determining the solidification direction includes, for each hotspot,
determining that if volume of the hotspot in part is zero, then direction solidification is occurring,
determining a nearest feeder hotspot as the feeder hotspot;
determining a shortest path joining a core of the part hotspot and a core of the feeder hotspot along a skeleton, wherein the skeleton is determined using Palagyi's technique by defining the nearest voxel on the skeleton as end points; and
determining along the shortest path, if at any voxel, the difference between a voxel temperature and an end point temperature is more than a predefined temperature then considering the hotspot as not being fed and therefore determining that directional solidification is not occurring.
